(19) United States
(12) Patent Application Publication
(10) Pub. No.: US 2026/0094975 A1
(43) Pub. Date: Apr. 2, 2026

(54) Omnidirectional Conformal Antenna Power Pattern and Method Thereof

(71) Applicant: The United States of America, As Represented by the Secretary of the Navy, Arlington, VA (US)

(72) Inventor: David Alan Garren, Clifton, VA (US)

(21) Appl. No.: 18/903,117

(22) Filed: Oct. 1, 2024

(51) Int. Cl. H01Q 21/06; H01Q 21/00; H01Q 21/20

(52) U.S. Cl. CPC H01Q 21/065; H01Q 21/0006; H01Q 21/205

(57) ABSTRACT

An antenna, radiating an omnidirectional power pattern comprising: a spherical structure having a plurality of antennas and one or more inputs, the plurality of antennas being configured in an array and attached to the surface of the spherical structure; and the one or more inputs are electrically coupled to a distribution, the distribution being configured to distribute a first current and a second current to each antenna.

### STATEMENT OF GOVERNMENT INTEREST

The present disclosure was made in the performance of official duties by one or more employees of the Department of the Navy, and thus, embodiments herein may be manufactured, used or licensed by or for the Government of the United States of America for governmental purposes without the payment of any royalties thereon or therefor.

### FIELD OF USE

The present disclosure relates, in general, to an antenna for and method of radiating an omnidirectional power pattern. More specifically, the present disclosure relates to a nearly isotropic radiating antenna.

### BACKGROUND

Generally, antennas convert radio frequency energy between guided electromagnetic energy and radiated electromagnetic energy or vice versa. The guided portion is typically constrained to a transmission line and described electromagnetically, while the antenna's radiation pattern describes the radiated portion. The antenna pattern is a graphical representation of how the antenna radiates electromagnetic energy.

An ideal antenna is typically studied and described as an isotropic radiator, a hypothetical lossless antenna that radiates its energy equally in all directions. This imaginary antenna would have a spherical radiation pattern, and the principal plane cuts would be circles.

Unlike an isotropic radiator, typical antenna radiation patterns comprise nodal lines, nodal planes, and lobes, such as a main lobe, a side lobe, or a back lobe, and refer to that portion of the pattern in which the lobe appears. Generally, a nodal line or plane is an interference feature that may be observed in an antenna radiation pattern. A lobe is any part of the pattern that is surrounded by regions of relatively weaker radiation. The areas of weaker radiation may contain information that is lost or unusable. So, a lobe is any part of the pattern that “sticks out,” and the names of the various types of lobes are self-explanatory.

The longer the antenna relative to the radio wavelength, the more lobes its radiation pattern has. In transmitting antennas, excessive sidelobe radiation wastes energy and may cause interference with other equipment.

Finally, Antennas are typically frequency-limited because of impedance mismatch, which occurs when the input power of an antenna is significantly reflected outside of its bandwidth. This results in poor radiation.

Therefore, what is needed is a frequency-independent antenna that radiates an omnidirectional power pattern.

### INCORPORATION BY REFERENCE

The following publications are incorporated by reference in their entirety.
U.S. Pat. No. 12,057,645, issued to Aug. 6, 2024, by David Alan Garren.
David Alan Garren, Three-dimensional omnidirectional power pattern using rotating electric current sphere via exact maxwell solution, The Institute of Engineering and Technology, June 2024, volume 18, issue 6 at 838.

### SUMMARY

To minimize the limitations in the prior art, and to minimize other limitations that will become apparent upon reading and understanding the present specification, the present disclosure discloses a new and useful omnidirectional near isotropic radiating antenna.

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

The problem with power radiating from a conventional antenna is that nodal lines and planes are generated and that an antenna is limited by bandwidth or operating frequency.

Nodal lines and nodal planes are interference produced when exiting a traditional antenna with a time-varying electric current. By exciting an antenna array with an electric current density that rotates azimuthally on the surface of a contour or spherical structure, an antenna may radiate an omnidirectional and near-uniform radiation pattern without nodal lines or nodal planes. Orientating an antenna array to be fed azimuthally may also allow for a low input resistance and reactance, may allow an antenna to transmit multiple frequencies without tuning the antenna for each frequency.

One embodiment of the present disclosure may comprise a contoured structure, an antenna distribution, one or more antennas, and one or more current densities configured to feed the one or more antennas with an electric current density azimuthally around the contoured structure—the magnitude of the electric current density scales as the sine of the spherical polar angle. At the pole extremities, the polarization is circular and linearly polarized at the equator. At a polar angle between 1<θ>90 and 90<θ>180, the polarization transitions from linear to elliptical to circular or circular to elliptical to linear. The ideal contour is a sphere, but any contour may exhibit similar radiation patterns and benefits.

Another embodiment may be an antenna, radiating an omnidirectional power pattern comprising: a spherical structure having a plurality of antennas and inputs, the plurality of antennas being configured in an array and attached to the surface of the spherical structure; and the inputs being electrically coupled to a distribution, the distribution being configured to distribute a first current and a second current to each antenna. The first current is K_{θ}(r, t)=\tilde{K}₀ cos(wt±Φ) and the second current is K_{Φ}(r, t)=+\tilde{K}₀ cos(θ)sin(wt±Φ). An electric current density K_{θ}(r, t)=K_{θ(r,t)}\hat{θ}(θ, Φ)+K_{Φ(r,t)}\hat{Φ}(Φ) rotates azimuthally on the surface of the sphere, wherein at any fixed spatial location r on the surface of the sphere, the orthogonal \hat{θ}(θ, Φ) and \hat{Φ}(Φ) components of K_{(r,t)} are π/2 radians out of phase. The electric current density is a θ-dependent elliptical polarization over the surface of the sphere. The electric current density is a degenerate circular polarization at poles θ={0, π}. The electric current density is linearly polarized at

$$θ = \frac{π}{2} .$$

The antenna may be frequency independent. The antenna may radiate a 3-dimensional omnidirectional antenna power pattern proportional to 1+cosine²(θ). The plurality of antennas are patch antennas.

Another embodiment may be a conformal antenna array, radiating an omnidirectional power pattern comprising: a contoured structure having a plurality of antennas and inputs, the plurality of antennas configured to conform and attach to the surface of the contoured structure forming an array; and the inputs being electrically coupled to a distribution, the distribution being configured to distribute a first current and a second current to the plurality of antennas. The first current is K_{θ}(r, t)=\tilde{K}₀ cos(wt±Φ) and the second current is K_{Φ}(r, t)=±\tilde{K}₀ cos(θ)sin(wt±Φ). An electric current density K_{(r,t)}=K_{θ(r,t)}\hat{θ}(θ, Φ)+K_{Φ(r,t)}\hat{Φ}(Φ) rotates azimuthally on the surface of the contoured structure, wherein at any fixed spatial location r on the surface of the contoured structure, the orthogonal \hat{θ}(θ, Φ) and \hat{Φ}(Φ) components of K_{(r,t)} are π/2 radians out of phase. The electric current density is a θ-dependent elliptical polarization over the surface of the contoured structure. The electric current density is a degenerate circular polarization at poles θ={0, π}. The electric current density is linearly polarized at

$$θ = \frac{π}{2} .$$

The antenna may be frequency independent. The conformal antenna may radiate a 3-dimensional omnidirectional antenna power pattern proportional to 1+cosine²(θ).

Another embodiment may be a method of omnidirectionally radiating electromagnetic power comprising: providing antennas, wherein the antennas form an antenna array in the shape of a contoured volume or surface; providing electric current densities; distributing, by a distribution network, the electric current densities to feed each of the antennas a first current density and a second current density, wherein the first current is K_{θ}(r, t)=\tilde{K}₀ cos(wt±Φ) and the second current is K_{Φ}(r, t)=±\tilde{K}₀ cos(θ)sin(wt±Φ), and wherein the electric current density rotates azimuthally around a surface of the contoured volume or surface, wherein at any fixed spatial location r on the surface of the sphere, the orthogonal \hat{θ}(θ, Φ) and \hat{Φ}(Φ) components of K_{(r,t)} are π/2 radians out of phase; and radiating, by the antenna array, a cumulative power pattern proportional to 1+cosine²(θ). Providing multiple current densities of different in frequency. Encoding, by spread spectrum encoding, a stream of data across the different frequencies of the multiple current densities.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is one embodiment of a spherical antenna array having an array of turnstile antenna elements.

FIG. 2 is one embodiment of a spherical antenna array having an array of patch antenna elements.

FIG. 3 is a graph showing the input resistance for a spherical antenna array having a normalized radius based on wavelength.

FIG. 4 is a graph showing the input reactance for a spherical antenna array having a normalized radius based on wavelength.

FIG. 5 is a flow block diagram of one method of omnidirectionally radiating electromagnetic power.

### DETAILED DESCRIPTION OF THE ILLUSTRATIVE EMBODIMENTS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screenshot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

Furthermore, the one or more versions may be implemented as a method, apparatus, or article of manufacture using standard programming and/or engineering techniques to produce entirely hardware embodiment, an entirely software embodiment, or an embodiment combining software and hardware embodiments. Furthermore, the systems and methods may take the form of Non-transitory computer readable media. More particularly, the present methods and systems may take the form of web-implemented computer software or a computer program product. Any suitable computer-readable storage medium may be utilized including, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick).

Those skilled in the art will recognize many modifications may be made to this configuration without departing from the scope of the disclosed embodiments.

Embodiments of the systems and methods are described below with reference to schematic diagrams, block diagrams, and flowchart illustrations of methods, systems, apparatuses and computer program products. It will be understood that each block of the block diagrams, schematic diagrams, and flowchart illustrations, and combinations of blocks in the block diagrams, schematic diagrams, and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of the various embodiments of the device, method, and/or system. For example, as used herein, the terms “computer” and “computer system” generally refer to any device that processes information with an integrated circuit chip and/or central processing unit (CPU).

As used herein, the terms “software” and “application” refer to any set of machine-readable instructions on a machine, web interface, and/or computer system” that directs a computer's processor to perform specific steps, processes, or operations disclosed herein.

As used herein, the term “computer-readable medium” refers to any storage medium adapted to store data and/or instructions that are executable by a processor of a computer system. The computer-readable storage medium may be a computer-readable non-transitory storage medium and/or any non-transitory data storage circuitry (e.g., buggers, cache, and queues) within transceivers of transitory signals. The computer-readable storage medium may also be any tangible computer readable medium. In various embodiments, a computer readable storage medium may also be able to store data, which is able to be accessed by the processor of the computer system.

As used herein, the term “input resistance” refers to the resistance which is presented to the current from the source as a result of the absorption by an antenna of the applied RF energy as RF energy is being radiated.

Causing an electric current density to flow azimuthally on the surface of a spherical shell, wherein the magnitude of the electric current density scales as the sine of the spherical polar angle may yield closed-form expressions for the resulting electromagnetic (EM) fields without invoking any approximations involving the relative sizes of the radio frequency (RF) wavelengths, the sphere radius, or the distance to an observation point.

An electric current density having a related profile that rotates azimuthally on the surface of a sphere may generate a fully 3-dimensional (3D) omnidirectional power pattern that may not exhibit nodal lines and nodal planes. Additionally, the power pattern for the subject rotating sphere antenna concept is invariant to all RF frequencies.

A relationship between Cartesian unit vectors {\hat{x}, ŷ, \hat{z}} and spherical unit vector {\hat{r}(θ, Φ), \hat{θ}(θ, Φ), \hat{Φ}(Φ)} may be determined to be:

$$\hat{r} ( θ , Φ ) = sin ( θ ) cos ( Φ ) \hat{x} + sin ( θ ) sin ( Φ ) \hat{y} + cos ( θ ) \hat{z} ,$$

$$\hat{θ} ( θ , Φ ) = cos ( θ ) cos ( Φ ) \hat{x} + cos ( θ ) sin ( Φ ) \hat{y} - sin ( θ ) \hat{z} ,$$

$$\hat{Φ} ( Φ ) = - sin ( Φ ) \hat{x} + cos ( Φ ) \hat{y} .$$

The Cartesian unit and spherical unit vector relationship may may use to calculate the electromagnetic (EM) fields for the following time-dependent electric current density K_{θ}(r, t) that rotates azimuthally on the surface if a sphere of radius r=a:

$${K}_{θ} ( r , t ) = {\tilde{K}}_{0} cos ( ω t \pm Φ ) ,$$

$${K}_{Φ} ( r , t ) = \pm {\tilde{K}}_{0} cos ( θ ) sin ( ω t \pm Φ ) .$$

In terms of magnitude \hat{K} and the angular frequency ω, the upper and lower signs correspond with azimuthal rotation in the +\hat{Φ}(Φ) and [symbol] (Φ) directions, respectively. At any given fixed spatial location r on the surface of the sphere, the orthogonal \hat{θ}(θ, Φ) and \hat{Φ}(Φ) components of K(r, t) are π/2 radians out of phase. Thus, this surface electric current density corresponds to a θ-dependent elliptical polarization over the surface of the sphere, with the degenerate cases of circular polarization at the poles of θ={0, π} and linear polarization at the equator of θ=π/2.

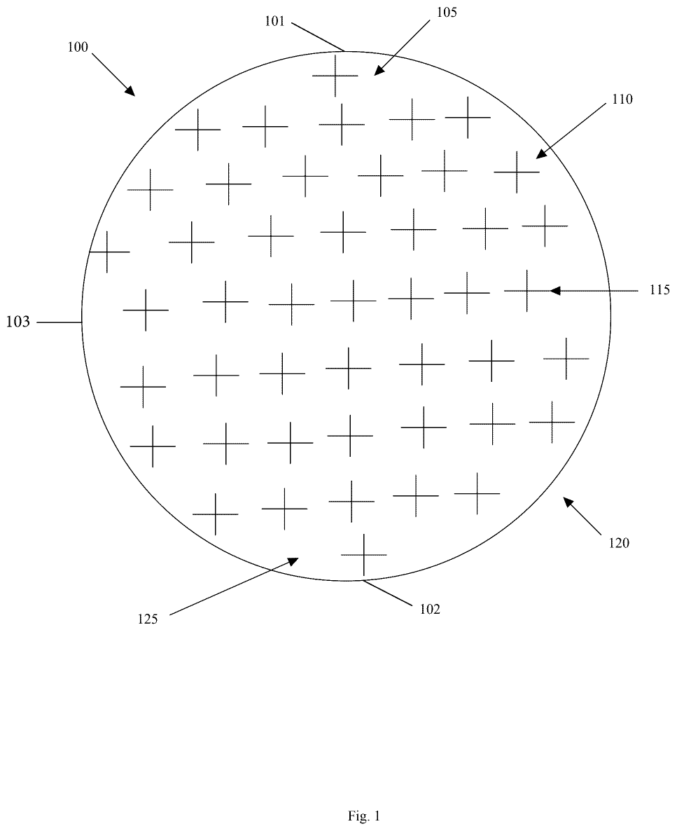

FIG. 1 is one embodiment of a spherical antenna array having an array of turnstile antenna elements. Antenna 100 may include a spherical structure 120, one or more turnstile antenna elements 105, 110, 115, and 125, north pole 101, south pole 102, and equator 103.

Spherical structure 120 may be a substrate, ground plane, or lattice to allow one or more turnstile elements 105, 110, 115, and 125 to be mounted or attached. Spherical structure 120 is preferably electrically isolated from each turnstile element 105, 110, 115, and 125. Spherical structure 120 may house transmission lines and a distribution (not shown).

Antenna 100 may be configured to accept one or more inputs. One or more inputs may be a single frequency or one or more pairs of phase quadrature frequency inputs. A single frequency input may be fed to antenna 100, which may require it to be split into two equal signals, with one being delayed by 90 degrees. Antenna 100 may include a radio frequency (RF) distribution (not shown) to provide electric current to each of the one or more turnstile elements 105, 110, 115, and 125. The distribution may include transmission lines, RF couplers, RF splitters, and miscellaneous impedance-matching elements.

Turnstile elements 105, 110, 115, and 125, or crossed-dipole antenna, may be a set of two identical dipole antennas mounted at right angles to each other and fed in phase quadrature. Turnstile elements 105, 110, 115, and 125 may be used in two modes: normal horizontally polarized and circularly polarized. Circular polarization is preferred because it is not sensitive to the orientation in space. Turnstile elements 105, 110, 115, and 125 may be sequentially and spirally distributed and attached around the surface of spherical structure 120. The distance between turnstile elements 105, 110, 115, and 125 may be determined by the wavelength an electric current density.

One or more inputs to antenna 100 may cause an electric current density to flow azimuthally on the surface of a spherical shell. The magnitude of the electric current density may scale as the sine of the spherical polar angle may yield closed-form expressions for the resulting electromagnetic (EM) fields.

Antenna 100 may radiate a 3D omnidirectional antenna power pattern proportional to 1+cosine²(θ) in the far field, which may be non-zero for all values of 0 and invariant with respect to φ. Antenna 100 may also exhibit 3D omnidirectional power patterns regardless of RF frequency.

Antenna 100 may have regions such as north pole 101, south pole 102, and equator 103. North pole 101, south pole 102, and equator 103 may express different polarizations of the electric current density. The electric current density may be circularly polarized at south pole 103, and at different φ toward equator 102, the polarization of the electric current density may become more elliptical, and at or near φ of equator 102, the polarization may become linear. The linearly polarized electric current density at or near φ of equator 102 may become more elliptical, and at or near φ of north pole 101, the polarization may be circular.

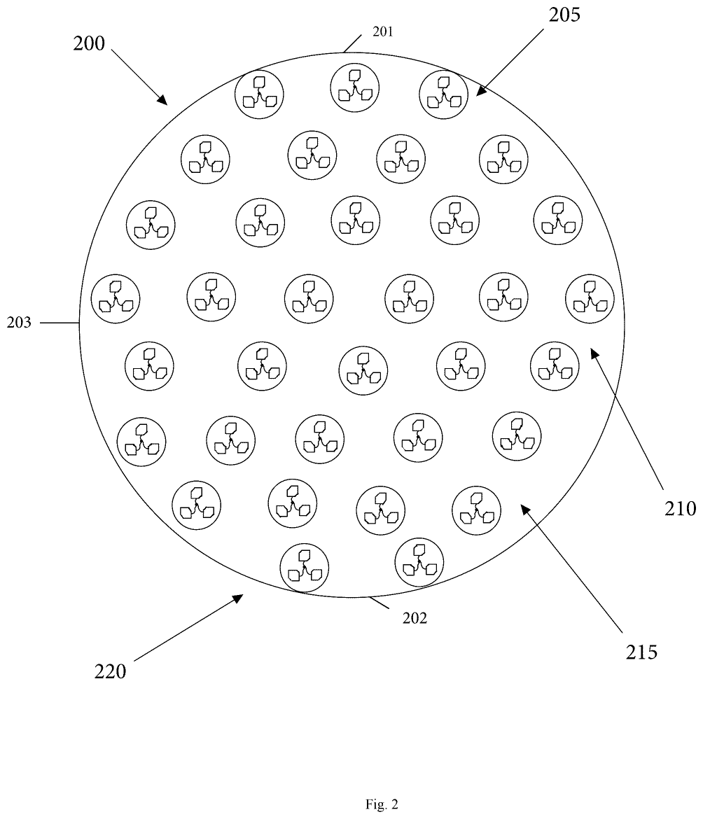

FIG. 2 is one embodiment of a spherical antenna array having an array of patch antenna elements. Antenna 200 may include a spherical structure 220, one or more patch antenna elements 205, 210, and 215, a north pole 201, a south pole 202, and an equator pole 203.

Spherical structure 220 may be a substrate, ground plane, or lattice to allow one or more patch antenna 205, 210, and 215 to be mounted or attached. Spherical structure 220 is preferably electrically isolated from each patch antenna 205, 210, and 215. Spherical structure 220 may house transmission lines and a distribution (not shown).

Antenna 200 may be configured to accept one or more inputs. One or more inputs may be a single frequency or one or more pairs of phase quadrature frequency inputs. A single frequency input may be fed to antenna 200, which may require it to be split into two equal signals, with one being delayed by 90 degrees. Antenna 200 may include a radio frequency (RF) distribution (not shown) to provide electric current to each of the one or more turnstile elements 205, 210, and 215. The distribution may include transmission lines, RF couplers, RF splitters, and miscellaneous impedance-matching elements.

Patch antennas 205, 210, and 215, as separately attached antennas manufactured using microstrip manufacturing techniques, offer simple construction and low-cost production. Their compatibility with flat and non-flat surfaces, variation in resonant frequency, polarization, pattern, and impedance make them a preferable choice. Patch antennas 205, 210, and 215 may be used in two modes, normal horizontally polarized and circularly polarized. The preference for circular polarization is due to its insensitivity to the orientation in space, which enhances the robustness of the design. Patch antennas 205, 210, and 215 may be sequentially and spirally distributed and attached around the surface of Spherical structure 220. The distance between Patch antennas 205, 210, and 215 may be determined by the wavelength an electric current density.

One or more inputs to antenna 200 may cause an electric current density to flow azimuthally on the surface of spherical structure 220. The magnitude of the electric current density may scale as the sine of the spherical polar angle may yield closed-form expressions for the resulting electromagnetic (EM) fields.

Antenna 200 may radiate a 3D omnidirectional antenna power pattern proportional to 1+cosine²(θ) in the far-field, which may be non-zero for all values of θ and invariant with respect to φ. Antenna 100 may also exhibit 3D omnidirectional power patterns regardless of RF frequency.

Antenna 200 may have regions such as north pole 201, south pole 202, and equator 203. North pole 201, south pole 202, and equator 203 may express different polarizations of the electric current density. The electric current density may be circularly polarized at south pole 203. At different φ toward equator 202, the polarization of the electric current density may become more elliptical, and at or near φ of equator 202, the polarization may become linear. The linearly polarized electric current density at or near φ of equator 202 may become more elliptical, and at or near φ of north pole 201, the polarization may be circular.

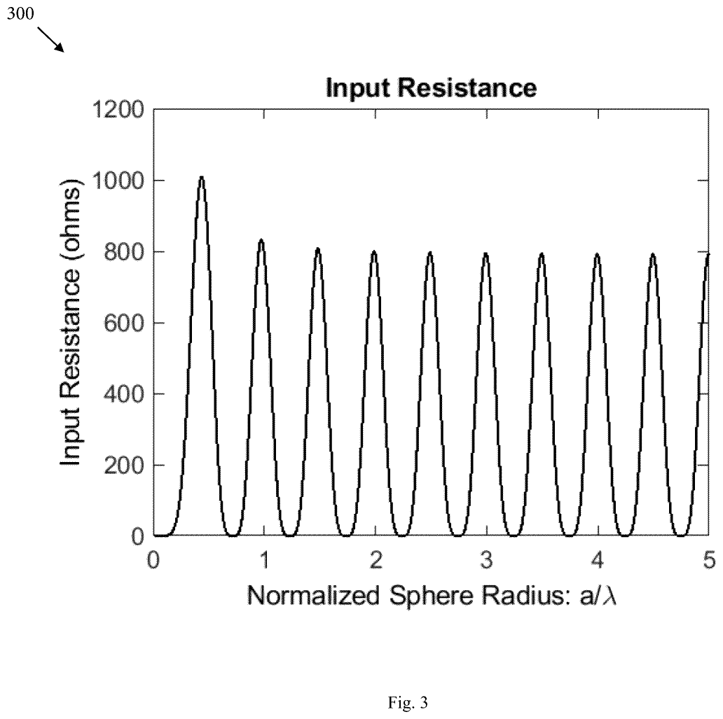

FIG. 3 is a graph showing the input resistance for a spherical antenna array having a normalized radius based on wavelength. As shown in FIG. 3, the radiation resistance exhibits low input resistance over multiple frequencies simultaneously.

In one embodiment, a conformal antenna may comprise multiple different carrier frequencies. The multiple carrier frequencies may include or be part of one or more source verification methods.

In an alternative embodiment, a conformal antenna may comprise multiple different carrier frequencies. One or more data signals (e.g., communication, data, etc.) may be transmitted over multiple different carrier frequencies to increase the frequency bandwidth of a system or to more efficiently utilize available equipment space. Similar to spread-spectrum techniques, a single antenna may establish secure communications, increase resistance to natural interference, noise, and jamming, prevent detection, limit power flux density (e.g., in satellite downlinks), and enable multiple-access communications.

In an alternative embodiment, a conformal antenna may comprise multiple different carrier frequencies. The multiple carrier frequencies may enable encrypted full duplex communications.

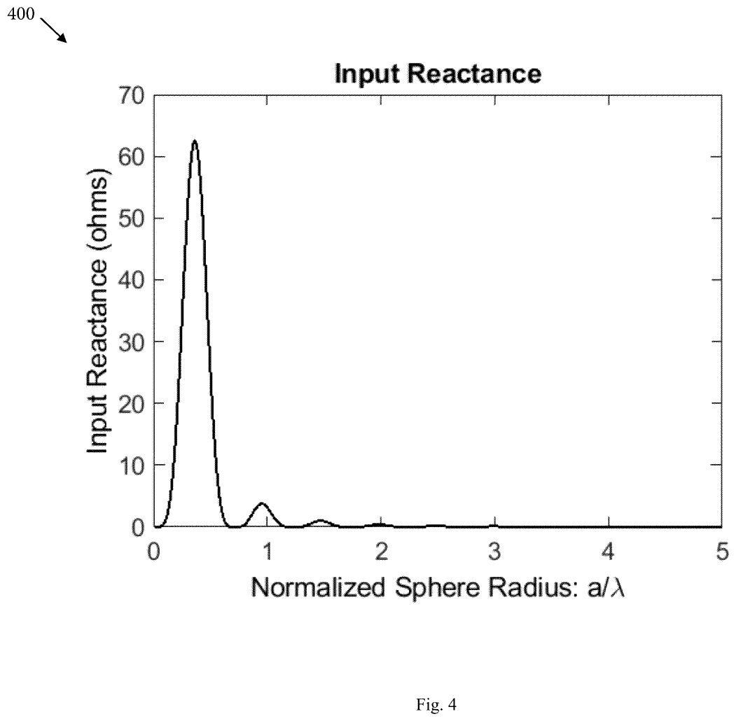

FIG. 4 is a graph showing the input reactance for a spherical antenna array having a normalized radius based on wavelength. As shown in FIG. 4, the input reactance exhibits strong resonance (low input impedance) over multiple frequencies simultaneously. Low input reactance may improve noise resistance and signal integrity.

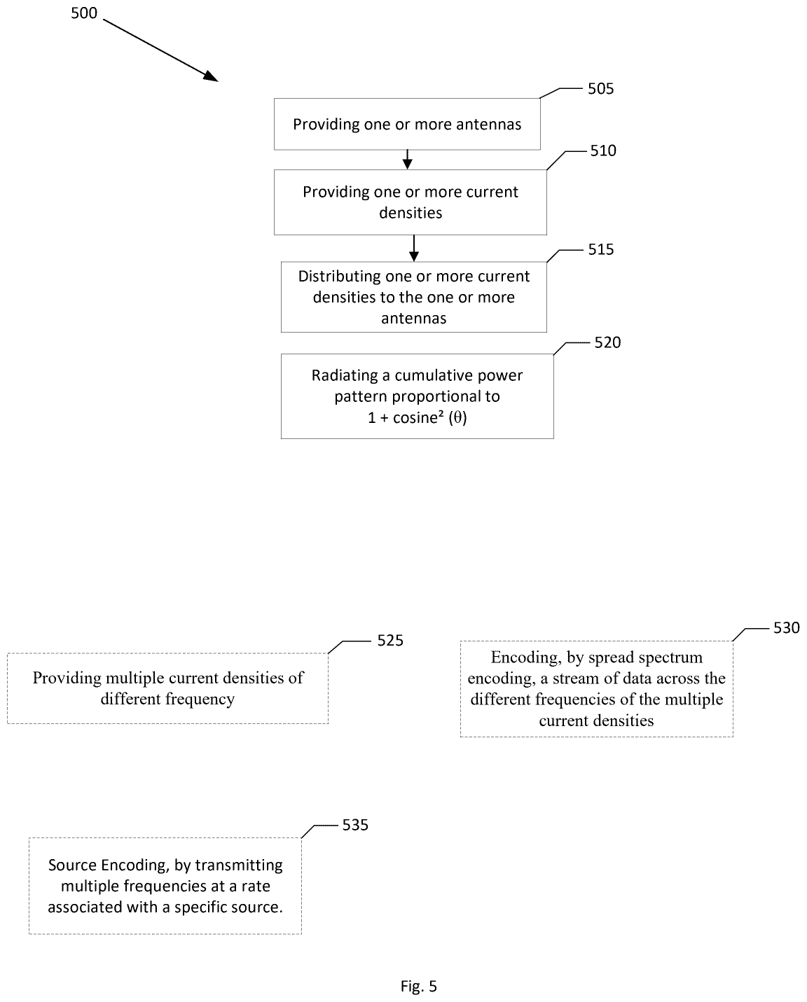

FIG. 5 is a flow block diagram of one method of omnidirectionally radiating electromagnetic power. In one embodiment, the method of omnidirectionally radiating electromagnetic power may comprise providing one or more antennas 505, wherein the one or more antennas form an antenna array in the shape of a contoured volume or surface; providing one or more electric current densities 510; distributing 515, by a distribution network, the one or more electric current densities to feed each of the one or more antennas a first current density and a second current density, wherein the first current is K_{θ(r,t)}=\tilde{K}₀ cos(wt±Φ) and the second current is K_{Φ(r,t)}=±\tilde{K}₀ cos(θ)sin(wt±Φ), and wherein the electric current density rotates azimuthally around a surface of the contoured volume or surface, wherein at any fixed spatial location r on the surface of the sphere, the orthogonal \hat{θ}(θ, Φ) and \hat{Φ}(Φ) components of K_{(r,t)} are π/2 radians out of phase; and radiating 520, by the antenna array, a cumulative power pattern proportional to 1+cosine²(θ).

An alternative embodiment of method 500 may further include providing 525 multiple current densities of different frequency.

An alternative embodiment of method 500 may include encoding 530, by spread spectrum encoding, a stream of data across the different frequencies of the multiple current densities.

An alternative embodiment of method 500 may further include transmitting multiple frequencies simultaneously or alternating transmission of multiple frequencies in a specific order, pattern, or rate to verify or identify a source of the transmission.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

Some portions of the preceding detailed descriptions have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the present disclosure, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The processes or methods depicted in the figures may be performed by processing logic that comprises hardware (e.g., circuitry, dedicated logic, etc.), firmware, software (e.g., embodied on a non-transitory computer readable medium), or a combination thereof. Although the processes or methods are described above in terms of some sequential operations, it should be appreciated that some of the operations described may be performed in a different order. Moreover, some operations may be performed in parallel rather than sequentially.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. An antenna, radiating an omnidirectional power pattern comprising:
a spherical structure having a plurality of antennas and one or more inputs, the plurality of antennas arranged in an array and attached to a surface of the spherical structure; and
the one or more inputs electrically coupled to a distribution, the distribution distributing a first current and a second current to each antenna of the plurality of antennas.

2. The antenna of claim 1, wherein the first current is described by K_{θ}(r, t)=\tilde{K}₀ cos(wt±Φ) and the second current is described by K_{Φ}(r, t)=±\tilde{K}₀ cos(θ)sin(wt±Φ).

3. The antenna of claim 1, wherein an electric current density K_{θ}(r, t)=K_{θ(r,t)}\hat{θ}(θ, Φ)+K_{Φ(r,t)}\hat{Φ}(Φ) rotates azimuthally on the surface of the sphere, wherein at any fixed spatial location r on the surface of the sphere, the orthogonal \hat{θ}(θ, Φ) and \hat{Φ}(Φ) components of K_{(r,t)} are π/2 radians out of phase.

4. The antenna of claim 3, wherein the electric current density is a θ-dependent elliptical polarization over the surface of the sphere.

5. The antenna of claim 3, wherein the electric current density is a degenerate circular polarization at poles θ={0, π}.

6. The antenna of claim 3, wherein the electric current density is linearly polarized at
$$θ = \frac{π}{2} .$$

7. The antenna of claim 1, further configured to be frequency independent.

8. The antenna of claim 1, wherein a radiation pattern is proportional to 1+cosine²(θ).

9. The antenna of claim 1, wherein the plurality of antennas are patch antennas.

10. A conformal antenna array, radiating an omnidirectional power pattern comprising:
a contoured structure having a plurality of antennas and one or more inputs, the plurality of antennas arranged to conform and attach to a surface of the contoured structure forming an array; and
the one or more inputs electrically coupled to a distribution, the distribution distributing a first current and a second current to each antenna of the plurality of antennas.

11. The conformal antenna array of claim 10, wherein the first current is described by K_{θ}(r,t)=\tilde{K}₀ cos(wt±Φ) and the second current is described by K_{Φ}(r, t)=±\tilde{K}₀ cos(θ)sin(wt±Φ).

12. The conformal antenna array of claim 10, wherein an electric current density K_{(r,t)}=K_{θ(r,t)}\hat{θ}(θ, Φ)+K_{Φ(r,t)}\hat{Φ}(Φ) rotates azimuthally on the surface of the contoured structure, wherein at any fixed spatial location r on the surface of the contoured structure, the orthogonal \hat{θ}(θ, Φ) and \hat{Φ}(Φ) components of K_{(r,t)} are π/2 radians out of phase.

13. The conformal antenna array of claim 12, wherein the electric current density is a θ-dependent elliptical polarization over the surface of the contoured structure.

14. The conformal antenna array of claim 12, wherein the electric current density is a degenerate circular polarization at poles θ={0, π}.

15. The conformal antenna array of claim 12, wherein the electric current density is linearly polarized at
$$θ = \frac{π}{2} .$$

16. The conformal antenna array of claim 10, wherein the antenna is frequency independent.

17. The conformal antenna array of claim 10, further configured to radiate a 3-dimensional omnidirectional antenna power pattern proportional to 1+cosine²(θ).

18. A method of omnidirectionally radiating electromagnetic power comprising:
providing one or more antennas, wherein the one or more antennas form an antenna array in the shape of a contoured volume or surface;
providing one or more electric current densities;
distributing, by a distribution network, the one or more electric current densities to feed each of the one or more antennas a first current density and a second current density, wherein the first current is K_{θ}(r, t)=\tilde{K}₀ cos(wt±Φ) and the second current is K₁₀₁ (r,t)=±\tilde{K}₀ cos(θ)sin(wt±Φ), and wherein the electric current density rotates azimuthally around a surface of the contoured volume or surface, wherein at any fixed spatial location r on the surface of the sphere, the orthogonal \hat{θ}(θ, Φ) and \hat{Φ}(Φ) components of K_{(r,t)} are π/2 radians out of phase; and
radiating, by the antenna array, a cumulative power pattern proportional to 1+cosine²(θ).

19. The method of claim 18, further comprising: providing multiple current densities of different in frequency.

20. The method of claim 19, further comprising: encoding, by spread spectrum encoding, a stream of data across the different frequencies of the multiple current densities.
